(19) United States
(12) Patent Application Publication
(10) Pub. No.: US 2026/0158467 A1
(43) Pub. Date: Jun. 11, 2026

(54) SMALL-PARTICLE-SIZE ALLOPHANE-AMIDOXIMATED POLYACRYLONITRILE COMPOSITE MATERIAL FOR URANIUM EXTRACTION FROM SEAWATER AND ITS PREPARATION METHOD

(71) Applicant: Guangdong University of Technology, Guangzhou (CN)

(72) Inventors: Peng Yuan, Guangzhou (CN); Qingcheng Zhang, Guangzhou (CN); Qingbin Xie, Guangzhou (CN)

(21) Appl. No.: 19/403,323

(22) Filed: Nov. 28, 2025

(30) Foreign Application Priority Data
Dec. 10, 2024 (CN) 2024118128319

(51) Int. Cl. B01J 20/26; B01J 20/28; C02F 1/28; C02F 101/00; C02F 103/08; C08F 8/32; C08F 20/44

(52) U.S. Cl. CPC B01J 20/265; B01J 20/28002; B01J 20/28007; B01J 20/28011; B01J 20/28021; B01J 20/2808; C02F 1/285; C08F 8/32; C08F 20/44; C02F 2101/006; C02F 2103/08

(57) ABSTRACT

A small-particle-size allophane-amidoximated polyacrylonitrile composite material and its preparation method are provided. By treating surface hydroxyl groups of nano-sized allophane with persulfate ions, short-chain polyacrylonitrile is successfully grafted onto the surface of allophane. After amidoximation conversion is completed, the composite material is obtained. The allophane effectively regulates the particle size of the composite material, allows aminoxime groups to be fully exposed, endows the composite material with excellent adsorption performance for uranyl ions. The synergistic effect between allophane and amidoximated polyacrylonitrile enables the composite material to have excellent suspension stability in solution and maintain outstanding structural stability and high adsorption capacity for uranium during the desorption and regeneration process. Additionally, the composite material has the advantages of a simple preparation process and low production cost, and has great application potential in uranium extraction from seawater.

### CROSS-REFERENCE TO RELATED APPLICATION

This application claims priority to Chinese patent application No. CN202411812831.9, filed to China National Intellectual Property Administration (CNIPA) on Jan. 21, 2025, which is herein incorporated by reference in its entirety.

### TECHNICAL FIELD

The disclosure relates to a uranium adsorption material and a preparation method thereof, belonging to the field of adsorption materials, water treatment, and nuclear chemical engineering, and more particularly to a small-particle-size allophane-amidoximated polyacrylonitrile composite material and a preparation method thereof.

### BACKGROUND

Uranium is a fundamental resource for the nuclear industry, and its reserves and mining technology directly impact a nation's defense and energy security. Nuclear power generation is an important clean energy source. By of the end of 2023, China operated 55 nuclear power units, with annual nuclear power generation reaching 440,000 gigawatt-hours, accounting for nearly 5% of the country's total cumulative electricity generation. The sustained operation of nuclear energy requires a stable supply of uranium resources. However, China's proven uranium ore reserves are only 2.8 million tons. Faced with such high consumption, ensuring the sustainable development of nuclear energy urgently requires increased investment in uranium exploration and mining.

Due to the relatively limited availability of uranium resources in the Earth's crust, approximately 99.9% of global uranium resources exist in seawater in the form of uranyl ions. Therefore, how to obtain uranium resources from seawater has become a strategic technology for ensuring the sustainable development of nuclear energy. Benefiting from its potential contribution to energy security, seawater uranium extraction technology was listed by the journal Nature in 2016 as one of seven separation technologies that could change the world. However, the concentration of uranium in seawater is extremely low (about 3.2 micrograms per liter abbreviated as μg/L), while starting a nuclear power plant typically requires hundreds of tons of uranium fuel. Consequently, how to efficiently enrich uranyl ions from seawater at low cost has become a key issue for the widespread adoption of nuclear energy.

Since the first publication on seawater uranium extraction by Davies et al. in 1964 (with reference to Davies et al., Extraction of Uranium from Sea Water, Nature, 1964, Vol. 203, pp.1110-1115), various methods for extracting uranium have been developed, including adsorption, solvent extraction, chemical precipitation, biological treatment, ion exchange, and superconducting magnetic separation. Specifically, the adsorption method has become a research focus due to its low cost, low energy consumption, and mature technology. Polymer materials containing amidoxime groups exhibit high adsorption capacity and selectivity for uranyl ions, making them popular candidate materials for uranium extraction from seawater.

The abundant nitrile functional groups in acrylonitrile and its polymers can be easily converted into the amidoxime groups through simple chemical reactions, making them widely used precursors for preparing uranyl ion adsorption materials. However, due to the limited accessibility of the amidoxime groups in large-particle-size polymers, the actual adsorption capacity of polyacrylonitrile-based adsorption materials is far lower than the theoretical capacity. Reported adsorption effects for uranium in related literature reach only 13.1 milligrams per gram (mg/g) (with reference to Xue Zhang et al., Polyamidoxime (PAO) granules for solar-enhanced uranium extraction from seawater, Environmental Science Advances, 2024, Vol.3, pp.44-50). Therefore, optimizing the material structure and controlling the particle size of the polymer to increase the accessibility of adsorption groups is an important direction for enhancing the adsorption capacity of these materials.

Chinese invention patent CN201710665074.0 (with publication number of CN107475798A) discloses a nanofiber material for uranium extraction from seawater and its preparation method, preparing nano-sized amidoximated polyacrylonitrile fibers via electrospinning for uranyl ion adsorption. This method partially addresses the issue of uranyl ion migration from seawater to the polyacrylonitrile fibers by preparing nanofibers, obtaining a relatively stable adsorption material. However, due to the steric hindrance effect during the diffusion of uranyl ions within the material, the adsorption effect of a single polyacrylonitrile material on uranyl ions remains limited. Researchers have attempted to compound two or more materials to overcome this problem. Chinese invention patent CN202210423039.9 (with publication number of CN114984924A) discloses a seawater uranium extraction adsorption material with nanopore structure and an aperture control preparation method, preparing an amidoximated bamboo strip composite material using bamboo strips as a substrate through cross-linking and hydrolysis reactions. This material has a nanopore structure, significantly promoting the diffusion effect of uranyl ions. However, the pre-treatment process for the bamboo strip substrate is complex, and the adsorption effect per unit mass is low, which is not conducive to the industrial application of seawater uranium extraction.

Furthermore, Chinese invention patent CN201910269879.2 (with publication number of CN109954484A) discloses a mesoporous silica gel particle-loaded amidoxime polymer uranium adsorption material and its preparation method. It prepares this material by using mesoporous silica gel particles as a substrate, loading finished polyacrylonitrile, and converting it to the amidoxime form. The adsorption material obtained through this process has a certain adsorption effect on uranyl ions. However, the process flow is complex, and the molecular weight of the amidoxime polymer in the final product depends entirely on the molecular weight of the polyacrylonitrile used in the raw material. This limitation is also not conducive to the industrial application of seawater uranium extraction. Therefore, selecting a composite phase with good synergy with polyacrylonitrile and obtaining a composite adsorption material through a simple preparation process is a research hotspot for developing industrial seawater uranium extraction adsorption materials.

Allophane is a nano-sized hydrous aluminosilicate clay mineral widely found in volcanic ash, possessing a unique short-range ordered structure. Its outer layer consists of aluminum-oxygen octahedra, and the inner layer consists of silicon-oxygen tetrahedra, coordinating to form a nano-hollow spherical structure of 3.5-5.0 nanometers (nm), with a large number of active aluminum hydroxyl groups on the outer surface. This structure gives allophane a large specific surface area and excellent reactivity, holding great potential for application in the adsorption field.

Currently, there are no reports on the application of allophane in materials for adsorbing uranyl ions. This is partly due to the complexity of the inorganic-organic compounding process for allophane, and partly due to limitations in existing research on its nanoscale properties. Therefore, developing a simple and efficient compounding method to construct a synergistic small-particle-size allophane-amidoximated polyacrylonitrile composite material is of great significance for preparing efficient composite adsorption materials applicable to industrial seawater uranium extraction engineering.

### SUMMARY

To address the deficiencies in the related art, an objective of the disclosure is to provide a small-particle-size allophane-amidoximated polyacrylonitrile composite material for uranium extraction from seawater and a preparation method and an application thereof.

A first objective of the disclosure is to provide a small-particle-size allophane-amidoximated polyacrylonitrile composite material for uranium extraction from seawater.

A second objective of the disclosure is to provide a preparation method of the aforementioned small-particle-size allophane-amidoximated polyacrylonitrile composite material for uranium extraction from seawater.

A third objective of the disclosure is to provide an application of the aforementioned small-particle-size allophane-amidoximated polyacrylonitrile composite material for uranium extraction from seawater.

To achieve the above objectives, the disclosure adopts the following technical solutions.

In a first aspect, the disclosure provides a small-particle-size allophane-amidoximated polyacrylonitrile composite material for uranium extraction from seawater. The composite material is obtained by polymerizing allophane with acrylonitrile initiated by persulfate ions, followed by an amidoximation reaction, and the allophane is nano-sized.

In an embodiment, the allophane has a particle size of 3.5-5.0 nanometers (nm), and the allophane has a nano-hollow spherical structure with defect pores of 0.3-0.5 nm. In an embodiment, the allophane is derived from an allophane suspension, the allophane suspension is a suspension of undried allophane.

In an embodiment, the polyacrylonitrile is prepared by polymerizing acrylonitrile monomers and compounding with the allophane during polymerization, and finally performing the amidoximation reaction using a hydroxylamine hydrochloride solution.

In an embodiment, the composite material has an average particle size of 26-35 nm, and the composite material has a median cluster size of 480-560 nm.

In an embodiment, a molar ratio of nitrile functional groups of the polyacrylonitrile to hydroxylamine hydrochloride is 1:0.1 to 1:10. In an embodiment, the polyacrylonitrile after polymerization has a relative molecular weight of 70,000-80,000.

In an embodiment, the mass ratio of the allophane to the acrylonitrile monomer is 2:1 to 20:1.

In an embodiment, the hydroxylamine hydrochloride solution is prepared by dissolving the hydroxylamine hydrochloride and an alkaline compound in methanol or water. The alkaline compound is one or more selected from sodium hydroxide, sodium carbonate, sodium bicarbonate, and potassium hydroxide. A molar ratio of the added alkaline compound to the hydroxylamine hydrochloride is 1:0.5 to 1:5. The hydroxylamine hydrochloride content in the hydroxylamine hydrochloride solution is 30-60 grams per liter (g/L), specifically 40-55 g/L.

The allophane suspension is prepared by a method including: mixing a sodium orthosilicate solution (Na₄SiO₄) at a certain concentration with an aluminum chloride hexahydrate solution (AlCl₃-6H₂O) at a certain concentration to obtain a mixture; under a condition controlling a silicon/aluminum molar ratio to 0.6-0.9, specifically 0.75-0.8, continuously stirring the mixture for 0.5-2 hours to obtain a precursor; centrifuging the precursor at a speed of 3000-8000 revolutions per minute (r/min) for 10-30 minutes to obtain a white precipitate; subjecting the white precipitate to hydrothermal treatment at 100° C. for 2-48 hours to obtain a product; and dialyzing the product with ultrapure water until a pH approaches neutral, to obtain the allophane suspension.

In an embodiment, a concentration of the sodium orthosilicate solution is 0.05-0.3 moles per liter (mol/L), and a concentration of the aluminum chloride hexahydrate is adaptively configured according to the concentration of the sodium orthosilicate solution based on the silicon/aluminum molar ratio.

In a second aspect, the disclosure provides a preparation method of the small-particle-size allophane-amidoximated polyacrylonitrile composite material for uranium extraction from seawater, including the following steps:
a) adding a persulfate ion solution to the allophane suspension, followed by stirring and reacting to obtain a reaction solution;
b) adding the acrylonitrile monomers to the reaction solution obtained in the step a), followed by heating and aging, to form a polyacrylonitrile/allophane composite material; and
c) subjecting the polyacrylonitrile/allophane composite material obtained in the step b) to the amidoximation reaction, to obtain the small-particle-size allophane-amidoximated polyacrylonitrile composite material.

In an embodiment, the persulfate ions are derived from any one or more selected from the group consisting of potassium persulfate, ammonium persulfate, and sodium persulfate; and a concentration of the persulfate ions is 1-10 g/L.

In an embodiment, the acrylonitrile monomer in the step b) is treated by methods such as distillation to remove polymerization inhibitors.

In an embodiment, the amidoximation reaction occurs in a liquid medium, and the liquid medium is any one selected from the group consisting of water, N, N-dimethylformamide, dimethyl sulfoxide, sulfolane, and ethylene glycol dinitrate.

In an embodiment, a concentration of the allophane suspension is 10-200 g/L, and the allophane is a synthetically prepared suspension and has not been dried.

The allophane suspension is prepared by a method, including: mixing a sodium orthosilicate solution (Na₄SiO₄) at a certain concentration with an aluminum chloride hexahydrate solution (AlCl₃-6H₂O) at a certain concentration to obtain a mixture; under a condition controlling a silicon/aluminum molar ratio to 0.6-0.9, specifically 0.75-0.8, continuously stirring the mixture for 0.5-2 hours to obtain a precursor; centrifuging the precursor at a speed of 3000-8000 r/min for 10-30 minutes to obtain a white precipitate; subjecting the white precipitate to hydrothermal treatment at 100° C. for 2-48 hours to obtain a product; and dialyzing the product with ultrapure water until a pH approaches neutral, to obtain the allophane suspension.

In an embodiment, a concentration of the sodium orthosilicate solution is 0.05-0.3 mol/L, and a concentration of the aluminum chloride hexahydrate is adaptively configured according to the concentration of the sodium orthosilicate solution based on the silicon/aluminum molar ratio.

In an embodiment, a molar ratio of nitrile functional groups of the polyacrylonitrile to hydroxylamine hydrochloride is 1:0.1 to 1:10. In an embodiment, the polyacrylonitrile after polymerization has a relative molecular weight of 70,000-80,000.

In an embodiment, the mass ratio of the allophane to the polyacrylonitrile is 2:1 to 20:1.

In an embodiment, the hydroxylamine hydrochloride solution is prepared by dissolving the hydroxylamine hydrochloride and an alkaline compound in methanol or water. The alkaline compound is one or more selected from sodium hydroxide, sodium carbonate, sodium bicarbonate, and potassium hydroxide. A molar ratio of the added alkaline compound to the hydroxylamine hydrochloride is 1:0.5 to 1:5. The hydroxylamine hydrochloride content in the hydroxylamine hydrochloride solution is 30-60 g/L, specifically 40-55 g/L.

In an embodiment, reaction time in the step a) is 0.1-3 hours.

In an embodiment, heating and aging time in the step b) is 1-4 hours, specifically 2-3 hours, and reaction time after adding the acrylonitrile monomers is 0.1-3 hours, specifically 0.5-0.8 h.

In an embodiment, amidoximation conversion time in the step c) is 15-30 hours, specifically 18-25 hours, more specifically 20 hours.

In an embodiment, the obtained composite material exhibits characteristic chemical bonds of amidoximated polyacrylonitrile, such as C—H (2933, 2856 cm⁻¹), C—N (1391 cm⁻¹), and C═N (1650 cm⁻¹), as well as characteristic chemical bonds of allophane, such as Si—O—(Al) (982 cm⁻¹) and Si—O—Al (680 cm⁻¹).

In a third aspect, the disclosure provides an application of the small-particle-size allophane-amidoximated polyacrylonitrile composite material for uranium extraction from seawater, including: adsorbing uranyl ions at room temperature, and a concentration of the uranyl ions is 8-20 parts per million (ppm).

In an embodiment, the adsorption capacity of the small-particle-size allophane-amidoximated polyacrylonitrile composite material at room temperature within 2-5 h, under conditions where the uranyl ion concentration is 8-20 ppm, is 320-480 milligrams per gram (mg/g) for uranyl ions.

In an embodiment, the small-particle-size allophane-amidoximated polyacrylonitrile composite material still maintains no less than 85% of its adsorption capacity for the uranyl ions after 5-10 regeneration cycles.

Compared with the related art, the disclosure has beneficial effects as follows.

The disclosure creatively utilizes the nanostructure and surface group characteristics of allophane to construct the small-particle-size allophane-amidoximated polyacrylonitrile composite material, its preparation method, and application through a compounding reaction with the acrylonitrile monomers.
1. The unique nano-spherical structure and surface hydroxyl characteristics of allophane are utilized to construct an allophane-amidoximated polyacrylonitrile composite material rich in adsorption sites for uranyl ions. The surface of allophane possesses a large number of active hydroxyl sites, which can serve as initiation and termination points for the acrylonitrile polymerization reaction. Its unique nano-spherical structure allows it to disperse uniformly in the reaction solution, effectively interrupting overly long main chains formed during acrylonitrile polymerization, avoiding the folding and twisting that occur in single-phase polyacrylonitrile due to excessively long main chains. Consequently, the amidoxime groups in the allophane-amidoximated polyacrylonitrile composite material are fully exposed, significantly suppressing the steric hindrance effect within the material during adsorption, enabling the composite material to efficiently capture a large number of uranyl ions, thus exhibiting excellent adsorption performance.
2. The synergistic effect between allophane and polyacrylonitrile imparts excellent suspension properties and structural stability to the composite material. The allophane-polyacrylonitrile composite material of the disclosure, after amidoximation conversion, has an average particle size of only about 30 nm and maintains a small cluster size in solution (about 542 nm), resulting in excellent suspension properties in solution. It can remain suspended in aqueous solution for long periods, effectively preventing sedimentation and failure of the adsorption material during uranyl ion adsorption, allowing the material to maintain excellent adsorption capacity for uranyl ions in static solutions. This is beneficial for applying this material in passive adsorption bed scenarios during the seawater uranium extraction process, helping to reduce energy consumption and maintenance costs of adsorption equipment. In addition, the separation of amidoxime groups from uranyl ions requires an alkaline environment, which can cause irreversible changes in the structure of the adsorption material, such as main chain scission. By grafting short-chain polyacrylonitrile onto the allophane surface, a short-chain amidoximated polyacrylonitrile adsorption system with allophane as the core is constructed. This short-chain polymer maintains good structural stability under alkaline conditions, significantly reducing failure caused by main chain scission during the regeneration process. Therefore, this material can maintain high adsorption efficiency over multiple cycles, making it suitable for continuous application scenarios such as seawater uranium extraction.
3. The “one-step” in-situ copolymerization achieves inorganic-organic polymerization, offering the advantage of a simple preparation method. Using the persulfate ions to treat the hydroxyl groups on the allophane surface promotes polymerization between the allophane and the acrylonitrile monomers, avoiding the step of additional organic modification of the inorganic material using modifiers like silanes required in traditional inorganic-organic composite material preparation processes. The hydrolysis products of the persulfate ions can not only promote the conversion of surface hydroxyl groups on allophane to alkoxy radicals but also subsequently open the double bonds of the acrylonitrile monomers, initiating polymerization between the two under relatively mild conditions. Therefore, this “one-step” process reduces production complexity and raw material costs, creating favorable conditions for the practical industrial application of uranyl ion adsorption materials.

### BRIEF DESCRIPTION OF DRAWINGS

FIG. 1 illustrates an X-ray diffraction (XRD) pattern of a small-particle-size allophane-amidoximated polyacrylonitrile composite material according to an embodiment 1 of the disclosure.

FIG. 2 illustrates a Fourier transform infrared (FT-IR) spectrum of the small-particle-size allophane-amidoximated polyacrylonitrile composite material according to the embodiment 1 of the disclosure.

FIG. 3 illustrates a transmission electron microscopy (TEM) image of the small-particle-size allophane-amidoximated polyacrylonitrile composite material according to an embodiment 2 of the disclosure.

FIG. 4 illustrates a laser particle size (LPS) analysis diagram of the small-particle-size allophane-amidoximated polyacrylonitrile composite material in an aqueous solution according to the embodiment 2 of the disclosure.

### DETAILED DESCRIPTION OF EMBODIMENTS

The disclosure will be described in detail below with reference to specific embodiments. However, the scope of implementation and protection of the disclosure is not limited to the following embodiments.

### Embodiment 1

1) 0.5 milliliters (mL) of an allophane suspension with a concentration of 100 g/L is taken. 9 mL of a potassium persulfate solution with a concentration of 5.56 g/L is added thereto to obtain a mixture, and the mixture is stirred for 0.5 hours to obtain a reaction solution.
2) 0.5 mL of acrylonitrile is added to the reaction solution obtained in the step 1), stirred for 0.5 hours, then heated to 70° C. and aged for 2 hours to obtain a polyacrylonitrile/allophane composite material.
3) 5.3 grams (g) of hydroxylamine hydrochloride is added to 100 mL of water. After complete dissolution, a mixed powder of 3.6 g of sodium carbonate and 0.9 g of sodium hydroxide is added. After stirring, 0.5 g of the polyacrylonitrile/allophane composite material obtained in the step 2) is added, then heated to 70° C. and maintained for 20 hours to complete amidoximation conversion of the polyacrylonitrile in the polyacrylonitrile/allophane composite material, thereby obtaining a small-particle-size allophane-amidoximated polyacrylonitrile composite material of this embodiment.

FIG. 1 shows an XRD pattern of the small-particle-size allophane-amidoximated polyacrylonitrile composite material of this embodiment. Analysis results indicate the simultaneous presence of diffraction peaks characteristic of both the amidoximated polyacrylonitrile and the allophane, demonstrating the coexistence of both components in the small-particle-size allophane-amidoximated polyacrylonitrile composite material.

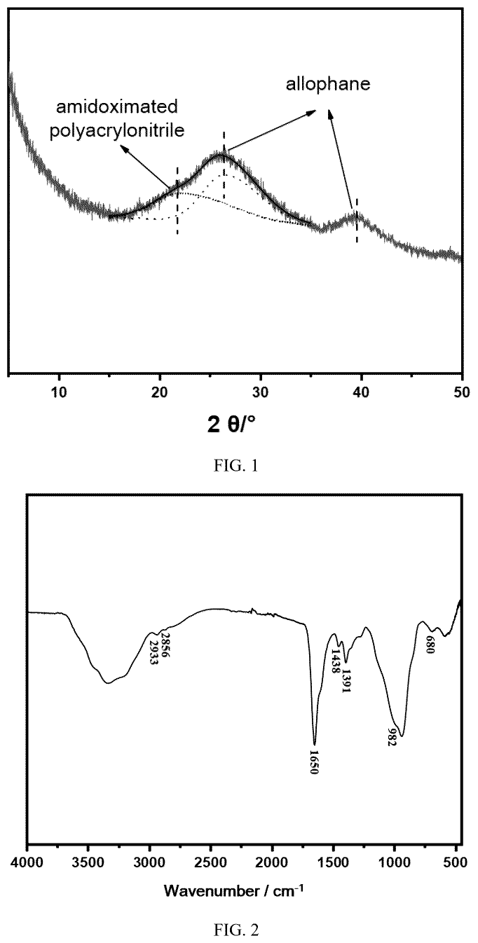

FIG. 2 shows a FT-IR spectrum of the small-particle-size allophane-amidoximated polyacrylonitrile composite material of this embodiment. The results show the simultaneous presence of characteristic chemical bonds of the amidoximated polyacrylonitrile, such as C—H (2933, 2856 cm⁻¹), C—N (1391 cm⁻¹), and C═N (1650 cm⁻¹), as well as characteristic chemical bonds of the allophane, such as Si—O—(Al) (982 cm⁻¹) and Si—O—Al (680 cm⁻¹), further proving the coexistence of the amidoximated polyacrylonitrile and the allophane in the small-particle-size allophane-amidoximated polyacrylonitrile composite material.

After adsorption for 5 hours in 100 mL of a uranyl solution with a uranium concentration of 8 ppm, the uranium adsorption capacity of the small-particle-size allophane-amidoximated polyacrylonitrile composite material obtained in the embodiment 1 reaches 413.3 mg/g.

### Embodiment 2

1) 0.5 mL of an allophane suspension with a concentration of 30 g/L is taken. 9 mL of a potassium persulfate solution with a concentration of 6 g/L is added thereto to obtain a mixture, and the mixture is stirred for 0.5 h to obtain a reaction solution.
2) 0.5 mL of acrylonitrile is added to the reaction solution obtained in the step 1), stirred for 0.5 hours, then heated to 70° C. and aged for 2 hours to obtain a polyacrylonitrile/allophane composite material.
3) 2.5 g of hydroxylamine hydrochloride is added to 30 mL of dimethylformamide. After complete dissolution, a mixed powder of 2.0 g of sodium carbonate and 0.5 g of sodium hydroxide is added. After stirring, 0.1 g of the polyacrylonitrile/allophane composite material obtained in the step 2) is added, then heated to 70° C. and maintained for 20 hours. Then, an additional 2.0 g of sodium carbonate and 0.5 g of sodium hydroxide are supplemented and maintained for another 20 hours to complete amidoximation conversion of the polyacrylonitrile in the polyacrylonitrile/allophane composite material, thereby obtaining a small-particle-size allophane-amidoximated polyacrylonitrile composite material of this embodiment.

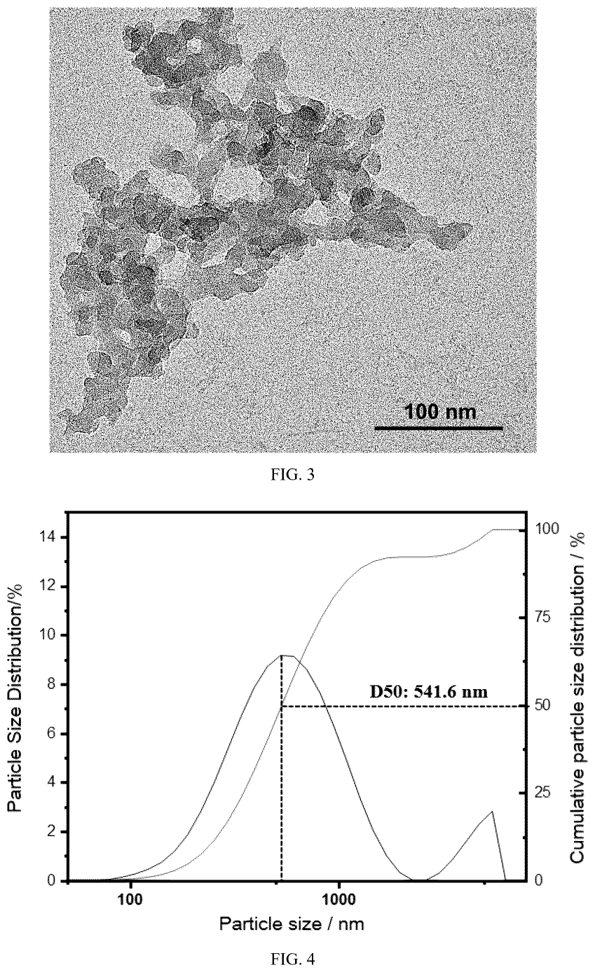

FIG. 3 shows a TEM image of the small-particle-size allophane-amidoximated polyacrylonitrile composite material of this embodiment. The results demonstrate that the particle size of the allophane-amidoximated polyacrylonitrile composite material in this embodiment is around 30 nm, forming clusters of about 500 nm after drying.

FIG. 4 shows a laser particle size analysis diagram of the small-particle-size allophane-amidoximated polyacrylonitrile composite material measured in water for this embodiment. According to the cumulative particle size distribution curve, the median cluster size of the small-particle-size allophane-amidoximated polyacrylonitrile composite material in this embodiment is 541.6 nm, indicating that the small-particle-size allophane-amidoximated polyacrylonitrile composite material synthesized in this embodiment maintains a small cluster size in water. This proves that the addition of allophane inhibits the agglomeration of amidoximated polyacrylonitrile in water, which is more conducive to suppressing the steric hindrance effect during the diffusion of uranyl ions therein.

After adsorption for 5 hours in a uranyl solution with a uranium concentration of 8 ppm, the uranium adsorption capacity of the small-particle-size allophane-amidoximated polyacrylonitrile composite material obtained in the embodiment 2 reaches 459.1 mg/g.

### Embodiment 3

1) 1.7 mL of an allophane suspension with a concentration of 58.3 g/L is taken. 18 mL of an ammonium persulfate solution with a concentration of 8 g/L is added thereto to obtain a mixture, and the mixture is stirred for 0.2 hours to obtain a reaction solution.
2) 1 mL of acrylonitrile is added to the reaction solution obtained in the step 1), stirred for 0.5 hours, then heated to 75° C. and aged for 2 hours to obtain a polyacrylonitrile/allophane composite material.
3) 3 g of hydroxylamine hydrochloride is added to 30 mL of N, N-dimethylformamide. After complete dissolution, a mixed powder of 2 g of sodium carbonate and 0.5 g of sodium hydroxide is added. After stirring, 0.2 g of the polyacrylonitrile/allophane composite material obtained in the step 2) is added, then heated to 75° C. and maintained for 5 hours to complete amidoximation conversion of the polyacrylonitrile in the polyacrylonitrile/allophane composite material, thereby obtaining a small-particle-size allophane-amidoximated polyacrylonitrile composite material of the embodiment 3.

After adsorption for 5 hours in 100 mL of a uranyl solution with a uranium concentration of 8 ppm, the uranium adsorption capacity of the small-particle-size allophane-amidoximated polyacrylonitrile composite material obtained in this embodiment reaches 327.6 mg/g. After desorption in a hot sodium hydroxide solution and regeneration for 5 cycles, it still retains a high adsorption capacity of 85.3% (i.e., 279.5 mg/g).

### Comparative Embodiment 1

1) 2 mL of a mesoporous silica gel particle suspension with a concentration of 35 g/L is taken. 20 mL of an ammonium persulfate solution with a concentration of 8 g/L is added thereto to obtain a mixture, and the mixture is stirred for 0.2 hours to obtain a reaction solution. The mesoporous silica gel particles are commercial mesoporous silica, with an average particle size of 200 nm and a pore size of 2 nm, sourced from Macklin Reagent M758933.
2) 1 mL of acrylonitrile is added to the reaction solution obtained in the step 1), stirred for 0.5 hours, then heated to 75° C. and aged for 2 hours to obtain a polyacrylonitrile/mesoporous silica gel particle composite material.
3) 3 g of hydroxylamine hydrochloride is added to 30 mL of N, N-dimethylformamide. After complete dissolution, a mixed powder of 2 g of sodium carbonate and 0.5 g of sodium hydroxide is added. After stirring, 0.2 g of the polyacrylonitrile/mesoporous silica gel particle composite material obtained in the step 2) is added, then heated to 75° C. and maintained for 5 hours to complete amidoximation conversion of the polyacrylonitrile in the polyacrylonitrile/mesoporous silica gel particle composite material, thereby obtaining a mesoporous silica gel particle-amidoximated polyacrylonitrile composite material of this comparative embodiment.

After adsorption for 5 hours in 100 mL of a uranyl solution with a uranium concentration of 8 ppm, the adsorption capacity of the mesoporous silica gel particle-amidoximated polyacrylonitrile composite material obtained in this comparative embodiment reaches 85.6 mg/g.

### Comparative Embodiment 2

1) 50 mg of allophane is taken and ultrasonically dispersed in 0.5 mL of water to obtain an allophane dispersion. 9 mL of a potassium persulfate solution with a concentration of 5.56 g/L is added to the above allophane dispersion and stirred for 0.5 hours to obtain a reaction solution. The allophane is the allophane powder obtained by drying the allophane suspension used in the embodiments 1-3.
2) 0.5 mL of acrylonitrile is added to the reaction solution obtained in the step 1), stirred for 0.5 hours, then heated to 70° C. and aged for 2 hours to obtain a polyacrylonitrile/allophane composite material.
3) 5.3 g of hydroxylamine hydrochloride is added to 100 mL of water. After complete dissolution, a mixed powder of 3.6 g of sodium carbonate and 0.9 g of sodium hydroxide is added. After stirring, 0.5 g of the polyacrylonitrile/allophane composite material obtained in the step 2) is added, then heated to 70° C. and maintained for 20 hours to complete amidoximation conversion of the polyacrylonitrile in the polyacrylonitrile/allophane composite material, thereby obtaining an allophane-amidoximated polyacrylonitrile composite material of this comparative embodiment.

After adsorption for 5 hours in 100 mL of a uranyl solution with a uranium concentration of 8 ppm, the adsorption capacity of the allophane-amidoximated polyacrylonitrile composite material obtained in this comparative embodiment reaches 102 mg/g.

### Comparative Embodiment 3

1) 25 mg of allophane is taken and ultrasonically dispersed in 0.5 mL of water to obtain an allophane dispersion. 9 mL of a potassium persulfate solution with a concentration of 5.56 g/L is added to the above allophane dispersion and stirred for 0.5 hours to obtain a reaction solution. The allophane is the allophane powder obtained by drying the allophane suspension used in the embodiments 1-3.
2) 0.5 mL of acrylonitrile is added to the reaction solution obtained in the step 1), stirred for 0.5 hours, then heated to 70° C. and aged for 2 hours to obtain a polyacrylonitrile/allophane composite material.
3) 5.3 g of hydroxylamine hydrochloride is added to 100 mL of water. After complete dissolution, a mixed powder of 3.6 g of sodium carbonate and 0.9 g of sodium hydroxide is added. After stirring, 0.5 g of the polyacrylonitrile/allophane composite material obtained in the step 2) is added, then heated to 70° C. and maintained for 20 hours to complete amidoximation conversion of the polyacrylonitrile in the composite material, thereby obtaining an allophane-amidoximated polyacrylonitrile composite material of this comparative embodiment.

After adsorption for 5 hours in 100 mL of a uranyl solution with a uranium concentration of 8 ppm, the adsorption capacity of the allophane-amidoximated polyacrylonitrile composite material obtained in this comparative embodiment reaches 35 mg/g.

### Comparative Embodiment 4

1) 50 mg of sodium montmorillonite is taken and ultrasonically dispersed in 0.5 mL of water to obtain a sodium montmorillonite dispersion. 9 mL of a potassium persulfate solution with a concentration of 5.56 g/L is added to the above sodium montmorillonite dispersion and stirred for 0.5 hours to obtain a reaction solution. The sodium montmorillonite is nano-sized powder.
2) 0.5 mL of acrylonitrile is added to the reaction solution obtained in the step 1), stirred for 0.5 hours, then heated to 70° C. and aged for 2 hours to obtain a polyacrylonitrile/sodium montmorillonite composite material.
3) 5.3 g of hydroxylamine hydrochloride is added to 100 mL of water. After complete dissolution, a mixed powder of 3.6 g of sodium carbonate and 0.9 g of sodium hydroxide is added. After stirring, 0.5 g of the polyacrylonitrile/sodium montmorillonite composite material obtained in the step 2) is added, then heated to 70° C. and maintained for 20 hours to complete amidoximation conversion of the polyacrylonitrile in the polyacrylonitrile/sodium montmorillonite composite material, thereby obtaining a sodium montmorillonite-amidoximated polyacrylonitrile composite material of this comparative embodiment.

After adsorption for 5 hours in 100 mL of a uranyl solution with a uranium concentration of 8 ppm, the adsorption capacity of the sodium montmorillonite-amidoximated polyacrylonitrile composite material obtained in this comparative embodiment reaches 62 mg/g.

The above embodiments represent illustrated implementations of the disclosure. However, the scope of the disclosure is not limited to these embodiments. Any modifications, variations, substitutions, combinations, or simplifications made without departing from the essential spirit and principles of the disclosure shall be considered equivalent replacements and are all encompassed within the scope of protection of the disclosure.

What is claimed is:

1. A small-particle-size allophane-amidoximated polyacrylonitrile composite material for uranium extraction from seawater, wherein the composite material is obtained by polymerizing allophane with acrylonitrile initiated by persulfate ions, followed by an amidoximation reaction; the allophane is nano-sized; the allophane has a particle size in a range of 3.5-5.0 nanometers (nm), and the allophane has a nano-hollow spherical structure with defect pores in a range of 0.3-0.5 nm, and the allophane is derived from an allophane suspension;
wherein the polyacrylonitrile is prepared by polymerizing acrylonitrile monomers and compounding with the allophane during polymerization, and finally performing the amidoximation reaction using a hydroxylamine hydrochloride solution;
wherein the composite material has an average particle size in a range of 26-35 nm and a median cluster size in a range of 480-560 nm; and
wherein the allophane suspension is prepared by a method comprising:
mixing a sodium orthosilicate solution at a certain concentration with an aluminum chloride hexahydrate solution at a certain concentration to obtain a mixture;
under a condition controlling a silicon/aluminum molar ratio to 0.6-0.9, continuously stirring the mixture for 0.5-2 hours to obtain a precursor;
centrifuging the precursor at a speed of 3000-8000 revolutions per minute (r/min) for 10-30 minutes to obtain a white precipitate;
subjecting the white precipitate to hydrothermal treatment at 100°C. for 2-48 hours to obtain a product; and
dialyzing the product with ultrapure water until a pH approaches neutral, to obtain the allophane suspension.

2. A preparation method of the small-particle-size allophane-amidoximated polyacrylonitrile composite material for uranium extraction from seawater as claimed in claim 1, comprising the following steps:
a) adding a persulfate ion solution to the allophane suspension, followed by stirring and reacting to obtain a reaction solution;
b) adding the acrylonitrile monomers to the reaction solution obtained in the step a), followed by heating and aging, to form a polyacrylonitrile/allophane composite material; and
c) subjecting the polyacrylonitrile/allophane composite material obtained in the step b) to the amidoximation reaction, to obtain the small-particle-size allophane-amidoximated polyacrylonitrile composite material;
wherein the allophane suspension is prepared by the method comprising:
mixing the sodium orthosilicate solution at the certain concentration with the aluminum chloride hexahydrate solution at the certain concentration to obtain the mixture;
under the condition controlling the silicon/aluminum molar ratio to 0.6-0.9, continuously stirring the mixture for 0.5-2 hours to obtain the precursor;
centrifuging the precursor at the speed of 3000-8000 r/min for 10-30 minutes to obtain the white precipitate;
subjecting the white precipitate to the hydrothermal treatment at 100°C. for 2-48 hours to obtain the product; and
dialyzing the product with the ultrapure water until the pH approaches neutral, to obtain the allophane suspension.

3. The preparation method as claimed in claim 2, wherein the persulfate ions are derived from any one or more selected from the group consisting of potassium persulfate, ammonium persulfate, and sodium persulfate; and a concentration of the persulfate ions is 1-10 grams per liter (g/L).

4. The preparation method as claimed in claim 3, wherein the amidoximation reaction occurs in a liquid medium, and the liquid medium is any one selected from the group consisting of water, N, N-dimethylformamide, dimethyl sulfoxide, sulfolane, and ethylene glycol dinitrate.

5. The preparation method as claimed in claim 4, wherein a concentration of the allophane suspension is 10-200 g/L.

6. An application of the small-particle-size allophane-amidoximated polyacrylonitrile composite material as claimed in claim 1, comprising: adsorbing uranyl ions at room temperature, wherein a concentration of the uranyl ions is 8-20 parts per million (ppm).

7. The application as claimed in claim 6, wherein an adsorption capacity at the room temperature within 2-5 hours is in a range of 320-480 milligrams per gram (mg/g).
